(19) United States
(12) Patent Application Publication
(10) Pub. No.: US 2010/0293915 A1
(43) Pub. Date: Nov. 25, 2010

(54) Articulating Hay Rake

(76) Inventors: James A. Westlake, Manheim, PA (US); Samuel K. Lapp, Peach Bottom, PA (US)

Correspondence Address: BARLEY SNYDER, LLC, 1000 WESTLAKES DRIVE, SUITE 275, BERWYN, PA, 19312, US

(21) Appl. No.: 12/470,129

(22) Filed: May 21, 2009

(51) Int. Cl. A01D 78/00; A01D 80/00

(52) U.S. Cl. 56/365; 56/369

(57) ABSTRACT

The present invention relates to an economical wheel rake having two arms that adjust from transport position to an operating position using a combination of an actuator and a dual axis articulating joint. The hay rake apparatus having a wheeled frame, a rake arm having a trailing end and a leading end, an intermediate arm having a first end connected to the frame and a second end which is fixed to the rake arm, a dual axis articulating joint connecting the frame to the intermediate arm, a telescoping actuator attached to the wheel frame using a first actuator joint and to the intermediate arm using a second actuator joint. The dual axis articulating joint is pivotable on a horizontal and a vertical axis when the telescoping actuator extends or retracts causing a longitudinal and a latitudinal angle between the intermediate arm and the frame to change. The rake arm and rake wheels are therefore moveable from an inoperable transport position to an operable position.

### FIELD OF THE INVENTION

The invention relates to a rake for gathering hay, in particular, it relates to an adjustable wheel rake capable of folding a set of wheel arms to parallel positions during transport and converging to a v-shape during operation.

### BACKGROUND

The goal of haymaking is to cut forage at a time when a farmer can capture the nutrients in a storable form, so it can be later feed to livestock at a time when they cannot feed on growing pastures. Once the forage is cut, it turns to hay, which must be spread and turned in order to promote better air circulation for drying of the forage underside.

Agricultural hay rakes are used to form windrows from the cut hay for later collection by a baler or for further drying. In modern times, hay rakes are mechanized and designed for many different types of farmers. Depending on its intended purpose, the modern hay rakes are selected from one of three types of hay rake: the parallel bar, the rotary or the wheel.

The parallel bar rake was once a popular choice for collecting hay, however, its popularity has declined in recent years. Because the parallel bar is constructed with a single rake arm, this type of rake is generally very bulky and quite limited in width. Further, the parallel bar rake cannot operate at the speeds of the other two.

Rotary rakes first became popular because of their ability to produce fluffier windrow. In fact, some rotary rakes are capable of functioning to rake or ted hay. The rake is constructed so it can aggressively collect hay on both sides of the machine. If the rotary rake is being used to ted hay, it essentially fluffs the hay in order to facilitate drying. Although the rotary rake is quite effective at its intended purpose, the rake is generally complicated in design and sometimes requires power from a tractor, which contributes to it relatively high cost. Additionally, at high speeds the rotary rake does not perform all that well.

Wheel rakes have become increasingly popular because of their cost and ability to cover a large area. Generally, wheel rakes consist of rotating tined wheel banks that collect cut hay to form windrows as the rake is drawn through the field. These wheel rakes can cover a wide area in order to increase efficiency in time and utility. However, the wider the rake arm the more heavier and more cumbersome that rake arm is during operation and transport.

As a result, twin arm shaped wheel rakes have become favorable considering that the rake arms can converge to a compact position during transport, yet extend to cover a large area during operation. Normally, twin arm rakes have a pair of folding arms that are pivotally attached at the end to the wheeled cart, and a pair of rake arms attached to the other end of the folding arms, which include a plurality of tine rake wheels. A user transports and stores the rake with the arms in a compact closed position, and then lowers the arm to an engaging position right before operating the rake.

U.S. Pat. No. 7,318,312 B2 discloses such a twin arm wheel rake, where the rake arm actively pivots at the folding arm when transitioning between transport and raking positions. In transport, the arms fold up to provide a more compact configuration. Further, '312 discloses a hay rake where the rake wheels fold and nest together for transport, so that the rake tines protrude less toward the outside, to present less of a hazard to bystanders. The reference, however, requires manual adjustment of a positioning arm to configure the wheel arm in a planar direction where the angle between the rake arm and the folding arm is manually adjustable. One disadvantage of this rake is that the transport position of the rake assembly is not as efficient, further requiring extra parts, steps, and downtime. The full weight of the wheel arm bears on the positioning arm during transport, and the rake arms cannot be adjusted between transport and operating positions.

As such, there is a need for adjustable wheel hay rakes that provide easy transition between the transport and operating positions.

### SUMMARY

It is an object of the present invention to provide an economical wheel rake having two arms that adjust from transport position to an operating position using a combination of an actuator and a dual axis articulating joint.

It is further an object of the invention to provide a hay rake apparatus having a wheeled frame, a rake arm having a trailing end and a leading end, an intermediate arm having a first end connected to the frame and a second end which is fixed to the rake arm, a dual axis articulating joint connecting the frame to the intermediate arm, a telescoping actuator attached to the wheel frame using a first actuator joint and to the intermediate arm using a second actuator joint. The dual axis articulating joint is pivotable on a horizontal and a vertical axis when the telescoping actuator extends or retracts causing a longitudinal and a latitudinal angle between the intermediate arm and the frame to change. The rake arm and rake wheels are therefore moveable from an inoperable transport position to an operable position.

### BRIEF DESCRIPTION OF THE DRAWINGS

The invention will be explained in greater detail in the following with reference to embodiments, referring to the appended drawings, in which:

FIG. 1 is a perspective view of a hay rake according to the invention in an transport position;

FIG. 2 is a side view of a hay rake according to the invention in an transport position;

FIG. 3 is a top view of a hay rake according to the invention in a transition position;

FIG. 4 is a perspective view of a hay rake according to the invention in a transition position;

FIG. 5 is a close-up perspective view of an actuator and a dual axis articulating joint according to the invention in an transport position;

FIG. 6 is a sectional front view of the dual axis articulating joint according to the invention in an transport position;

FIG. 7 is a front view of a hay rake according to the invention in an transport position;

FIG. 8 is a close-up perspective view of the actuator and the dual axis articulating joint according to the invention in a transition position;

FIG. 9 is a sectional front view of the dual axis articulating joint according to the invention in a transition position;

FIG. 10 is a top view of a hay rake according to the invention in an operable position;

FIG. 11 is a perspective view of a hay rake according to the invention in an operable position;

FIG. 12 is a close-up perspective view of the actuator and the dual axis articulating joint according to the invention in an operable position;

FIG. 13 is a side view of a rake arms and rake wheels according to the invention;

FIG. 14 is a close-up perspective view of a multi-position support bracket according to the invention.

### DETAILED DESCRIPTION OF THE EMBODIMENT(S)

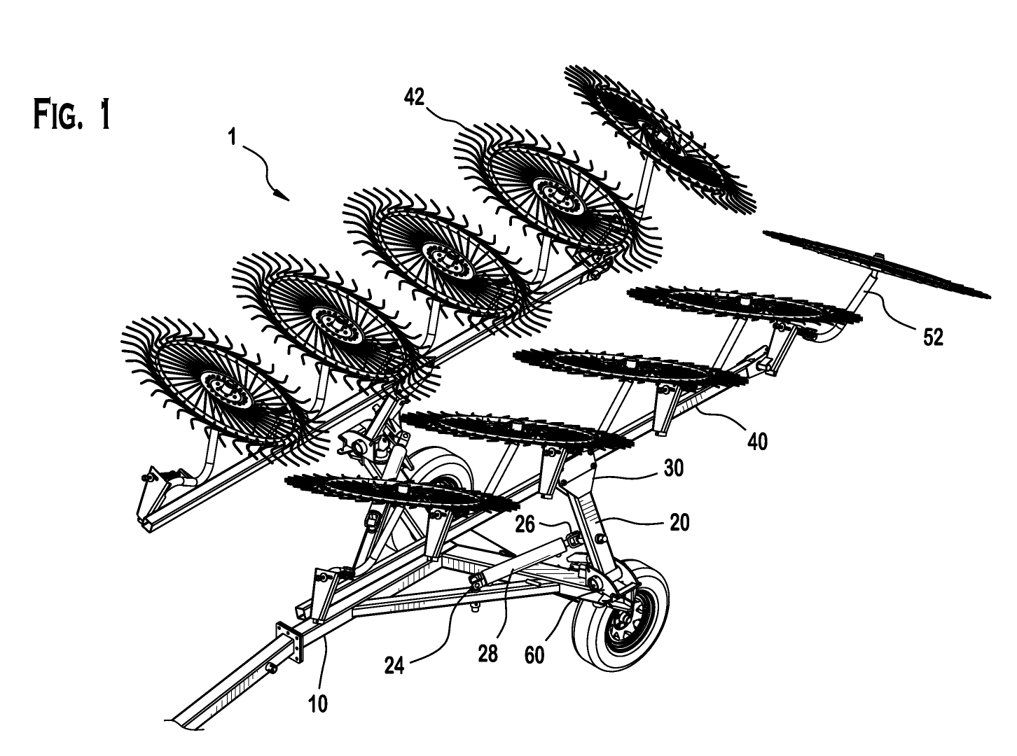

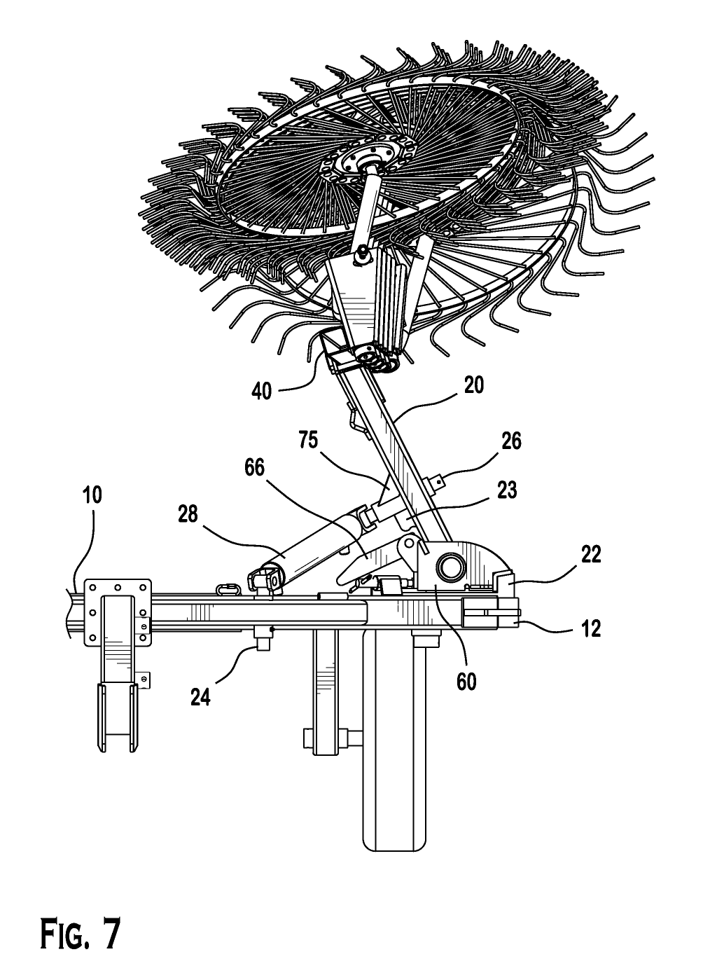

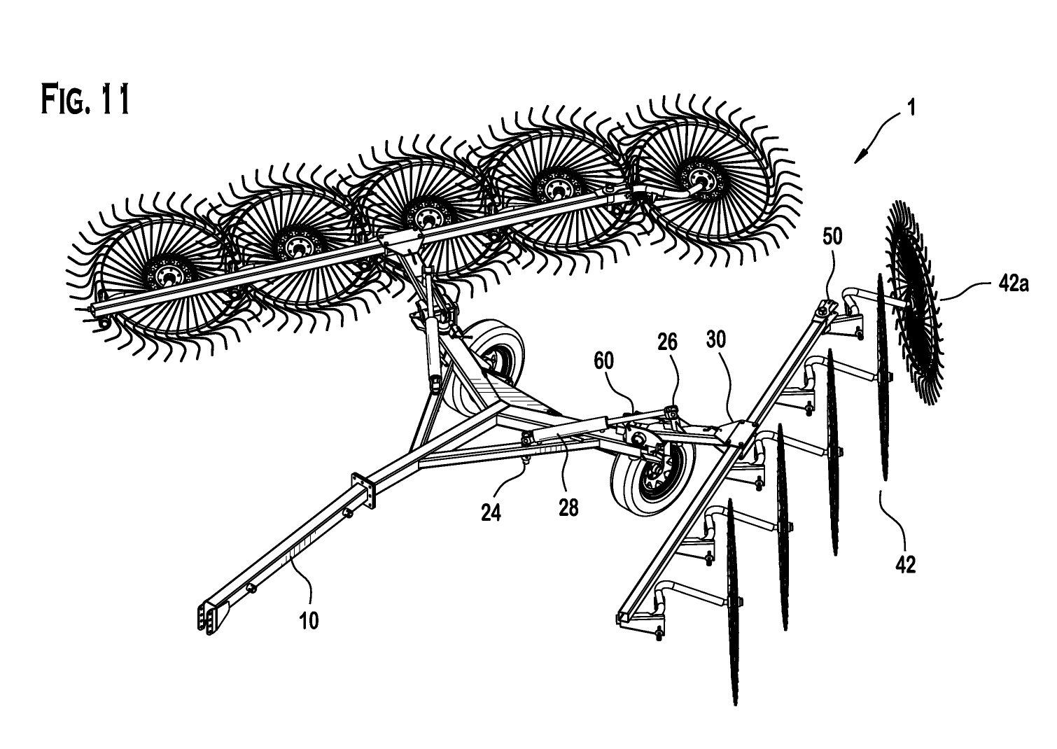

FIGS. 1-14 show an embodiment of a hay rake 1 according to the invention.

As shown in FIG. 1, the hay rake 1 includes a wheeled frame 10, a set of intermediate arms 20, a set of rake arms 40 rigidly attached to the intermediate arms 20 and supporting rake wheels 42. A first and second actuator joint 24, 26 connect an actuator 28 from the wheeled frame 10 to the intermediate arms 20, and a dual axis articulating joint 60 allows the intermediate arms 20 to pivot in both the vertical and horizontal axis when the actuator 28 extends. Although each rake arm 40 is shown as having five rake wheels 42 in the embodiment shown, it will be appreciated by those skilled in the art that each rake arm 40 may also be formed with two or more rake wheels 42, than the five displayed.

Each of the major components will be described in further detail below. Although the displayed embodiment shows a plurality of matching components, some of the drawings may hide one side of the hay rake 1. If the component is not shown, then the component may be described in the singular, instead of the plural. However, this does not mean that the described embodiment does not have or require a matching component.

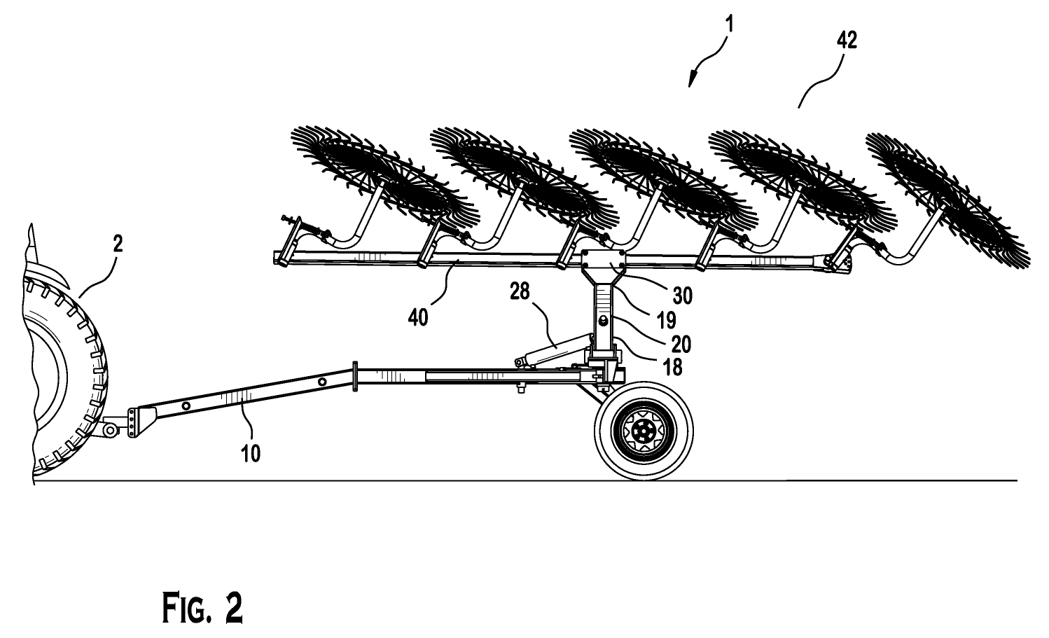

FIG. 2 is a side view of the hay rake 1 in a transport position. The wheeled frame 10, as shown, connects to a vehicle 2. The vehicle 2 connects to any mechanized parts (i.e. trailer hitch, hydraulics, etc.), additionally pulling the wheeled frame 10 through a field to form windrows of the cut hay.

An actuator 28 connects the wheeled frame 10 to a first end 18 of the intermediate arm 20. The second end 19 of the intermediate arms 20 rigidly attaches and supports the rake arms 40 through a fixed bracket assembly 30. Although the rake arm 40 and intermediate arm 20 assembly is shown connected perpendicularly in the embodiment shown, it will be appreciated by those skilled in the art that the rake arm 40 may be rigidly attached to the intermediate arm 20 at various angles.

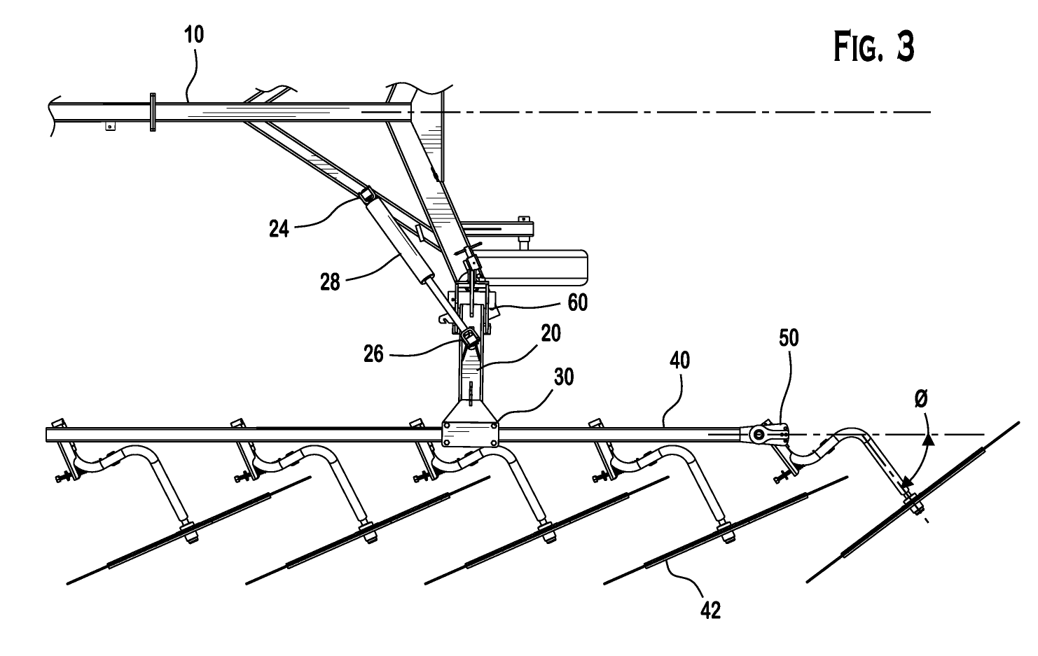

FIG. 3 is a top view of a hay rake 1, according to the invention, with the hay rake 1 in a transition position. As clearly illustrated, the actuator 28 connects to the wheeled frame 10 using a first actuator joint 24. The actuator 28 also connects to the intermediate arm 20 using a second actuator joint 26. The intermediate arm 20 is rigidly fixed to the rake arm 40 on one end of the intermediate arm, and pivotably attached to the wheeled frame 10 by a dual axis articulating joint 60.

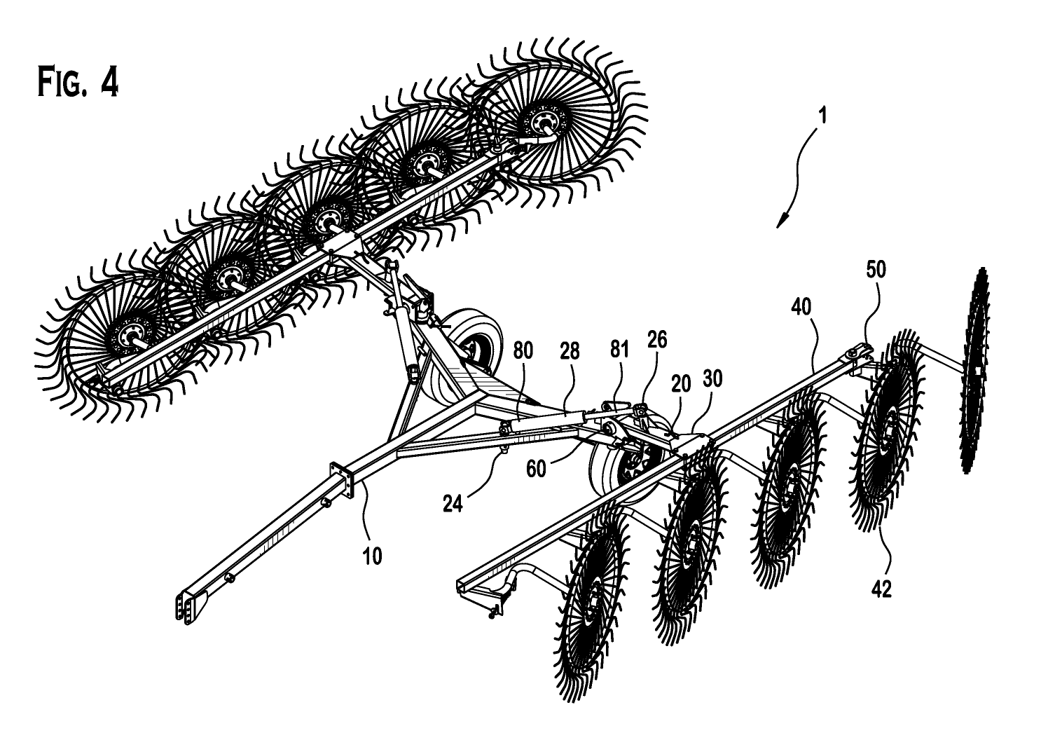

FIG. 4 is a perspective view of the hay rake 1, the hay rake 1 being in a transition position. Clearly, the two actuator joints 24, 26 are shown being positioned on the wheeled frame 10 and intermediate arm 20, respectively.

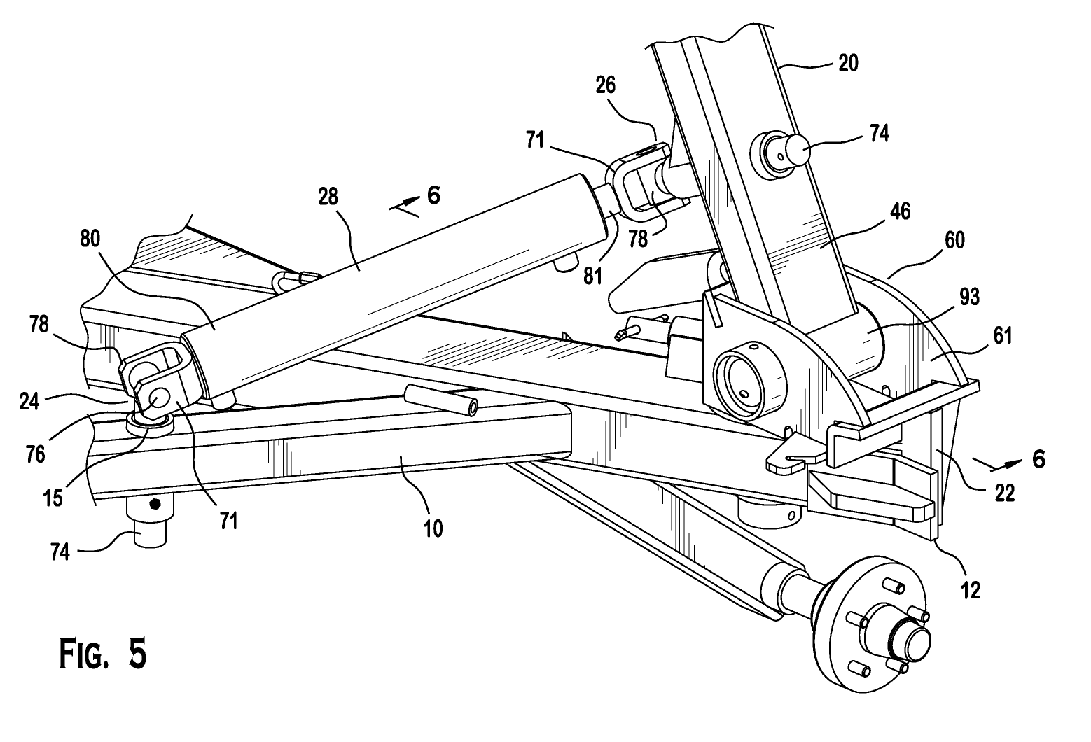

FIG. 5 shows a close-up perspective view of the two actuator joints 24, 26 and the dual axis articulating joint 60. As discussed above, the actuator 28 connects to the wheeled frame 10 and intermediate arm 20 through two actuator joints 24, 26. Although each joint 24, 26 is illustrated as a universal joint in the embodiment shown, it will be appreciated by those skilled in the art that each joint 24, 26 may be prepared using a different type of joint. However, any joint that is substituted should promote free motion in both along a vertical and horizontal axis.

In the embodiment shown, the first actuator joint 24 is a universal joint, which is also rigidly attached to the piston end 80 of the actuator 28 and to a guide rod 74, with the guide rod 74 extends through a an extended bushing lined opening 15 on the wheeled frame 10. This first actuator joint 24 includes a u-shaped connecter 71, which is rigidly attached to the piston end 80 of the actuator 28, and is then connected to the guide rod 74 using a pin 76. The u-shaped connector 71 connects to an articulating connector 78 of the guide rod 74. This connection is performed with the pin 76, but may be performed using a variety of known connections, such as a locking pin or screw, or by any means known to one skilled in the art.

A piston end 81 of the actuator 28 also consists of a universal joint, which connects to another guide rod 74, creating the second actuator joint 26. This second actuator joint 26 is rigidly attached to the piston end 81 of the actuator 28, which is also formed as another u-shaped connector 71, and rotably attached to articulating connector 78 of the guide rod 74. The articulating connector 78 may connect to the u-shaped connector 71 of the actuator 28, using an attachment means, such as a pin 76. However, any known connection would be suitable, including, but not limited, to a screw or locking pin.

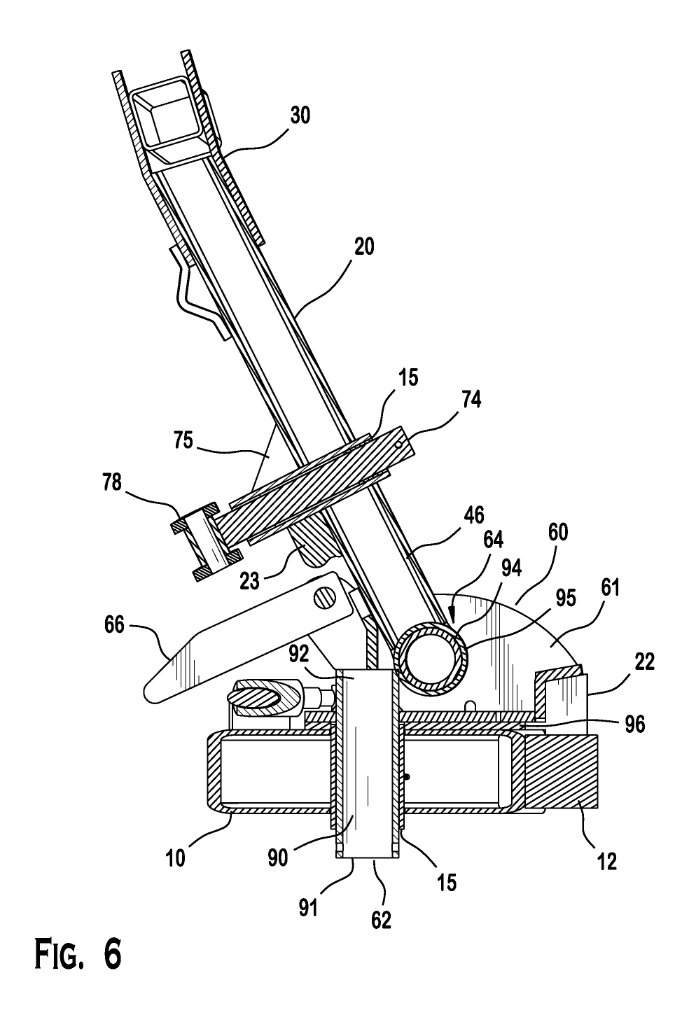

FIG. 6 shows a sectional front view of the intermediate arm 20 and the dual axis articulating joint 60. The drawing clearly illustrates how the guide rod 74 extends through an extended bushing lined opening 15 of the intermediate arm 20. Further, a footing 75 elongates this bushing lined opening 15. The footing 75 is design in such a way in order to fully support the opening 15. The second actuator joint 26 is positioned high enough so that the extending end 81 of the actuator 28 does not contact the dual axis articulating joint 60 when fully extended.

The guide rod 74 locks into position using another attaching means, which may be another locking pin (not shown).

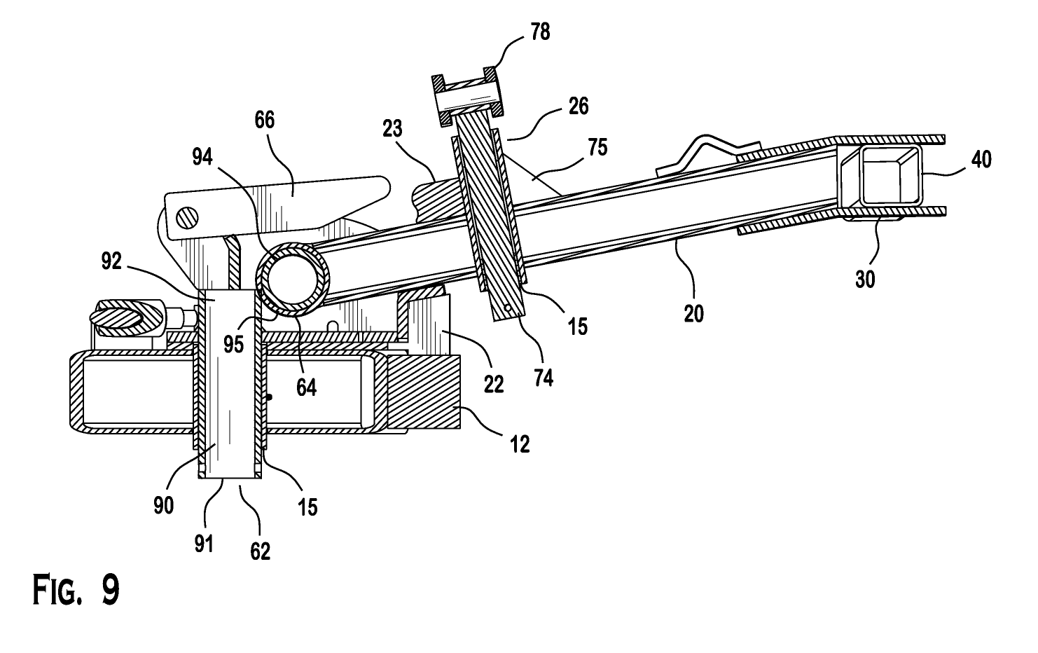

FIGS. 6 and 9 are sectional views, illustrating, inter alia, the articulating connector 78 of the guide rod 74, which includes a cavity to receive a locking pin 76 (see FIG. 5). In order to complete the universal joint (not shown), the locking pin 76 (see FIG. 5) connects the guide rod 74 and u-shaped connector 71. This same connection applies to the guide rod 74 and u-shaped connecter 71 used in the first actuator joint 24.

FIGS. 6 and 9 clearly show how the dual axis articulating joint 60 attaches to both the intermediate arm 20 and the wheeled frame 10. The dual axis articulating joint 60 includes two joints A horizontal axis joint 62 connects to the wheeled frame 10 through another bushing lined opening 15, which receives a vertical shaft 90 of the horizontal axis joint 62. The vertical shaft 90 is held into position using a locking means, such as a locking pin that is received by a recess in the leading end 91 of the vertical shaft 90. However, the vertical shaft 90 can be held into place by any locking means known to one skilled in the art. The vertical shaft 90 is an integral component of the dual axis articulating joint housing 61, located at the trailing end 44 of the vertical shaft 90. However, the vertical shaft 90 can be rigidly attached to the housing 61 as a separate component. The dual axis articulating joint 60 connects to the intermediate arm 20 using a second joint, a vertical axis joint 64.

FIG. 6 shows a sectional view of the dual axis articulating joint 60. Clearly the vertical axis joint 64 is shown having a horizontal shaft 94 that sits between a dual axis articulating joint housing 61. The vertical axis joint 64 is rigidly attached to a leading end 46 of the intermediate arm 20, and the horizontal shaft 94 is positioned inside the housing 61. During construction, the horizontal shaft 94 is first feed through a recess of the housing 61, and then rigidly attached to the intermediate arm 20.

In order to support the housing 61 and horizontal shaft 94, cylindrical support members 95 are positioned on the housing 61. These support members 95 are hollow and welded to the outside of the housing 61. Each support member 95 is lined with a bushing (not shown), and includes an opening, just large enough, to receive the horizontal shaft 94 and snugly fit with a bushing in-between.

The horizontal shaft 94 may be welded to the intermediate arm 20. However, any known rigid attachment may be used as an alternative. The horizontal shaft 94 of the dual axis articulating joint 60 can freely rotate along the vertical axis. Additionally, a dual axis joint bushing 96 is positioned between the housing 61 and the wheeled frame 10, in order to reduce friction and wear between the two components.

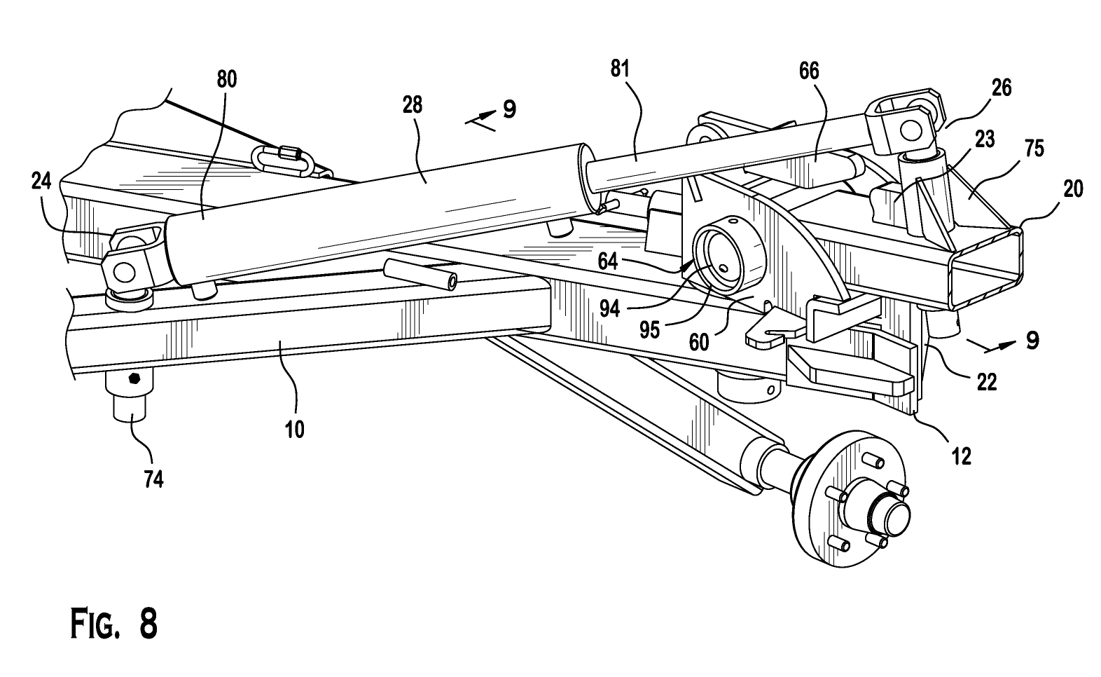

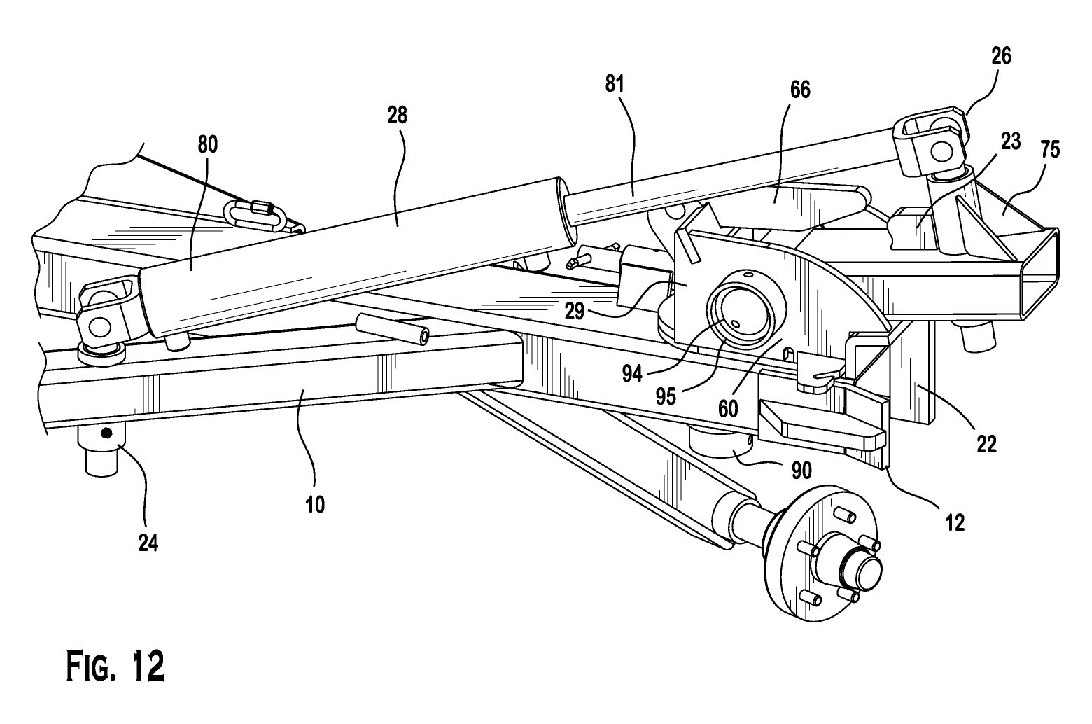

FIG. 8 shows a perspective view of the actuator 28 in an extending position. A rotatable lock 66 is attached to the dual axis articulating joint 60, while an intermediate arm notch 23 is formed on the intermediate arm 20. In the embodiment shown, the intermediate arm notch 23 is formed on the footing 75 of the intermediate arm 20. Further, FIGS. 8 and 12 illustrate a wheeled frame stop 12 and an intermediate arm stop 22. Both stops 12, 22 are positioned in such a way that the stops 12, 22 abut each other when the intermediate arm 20 is brought back along the horizontal axis to the transport position.

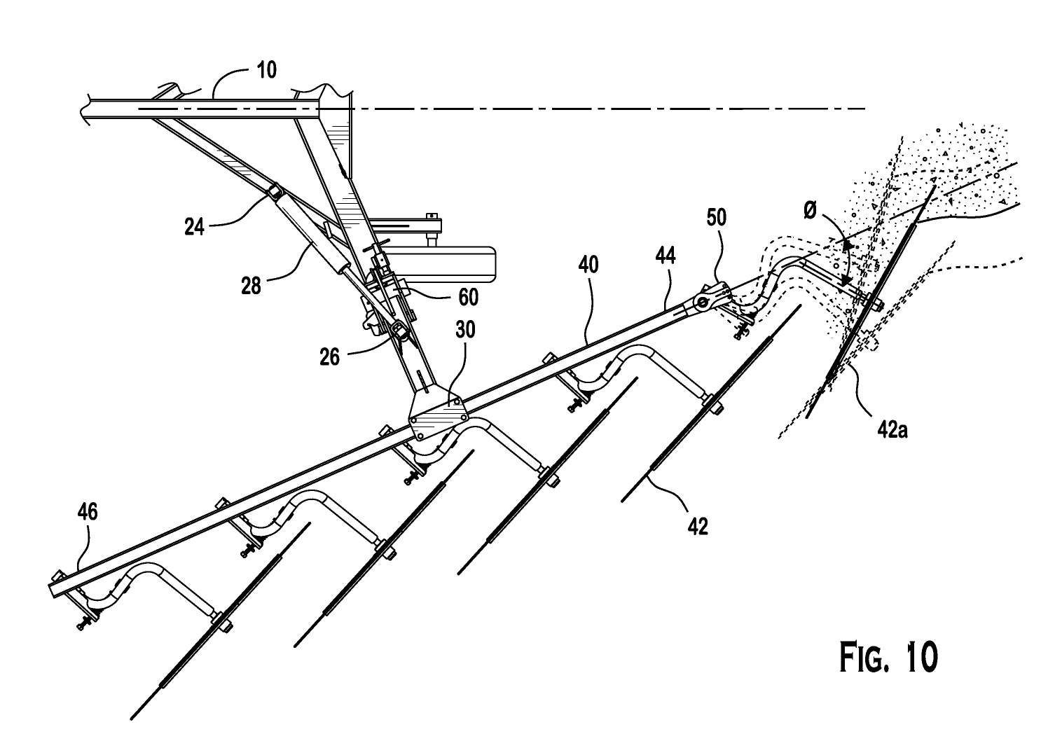

FIG. 10 shows a top view of the rake arm 40 having a leading end 46 and a trailing end 44. A multi-position support bracket 50 is positioned on the trailing end 44 of the rake arm 40, and is positioned in such a way that it is capable of adjustment along a horizontal axis of the rake arm 40, by an angle θ. A last rake wheel 42a is positioned on the trailing end 44 of the rake arm 40, and pivotably attached to the multi-position support bracket 50.

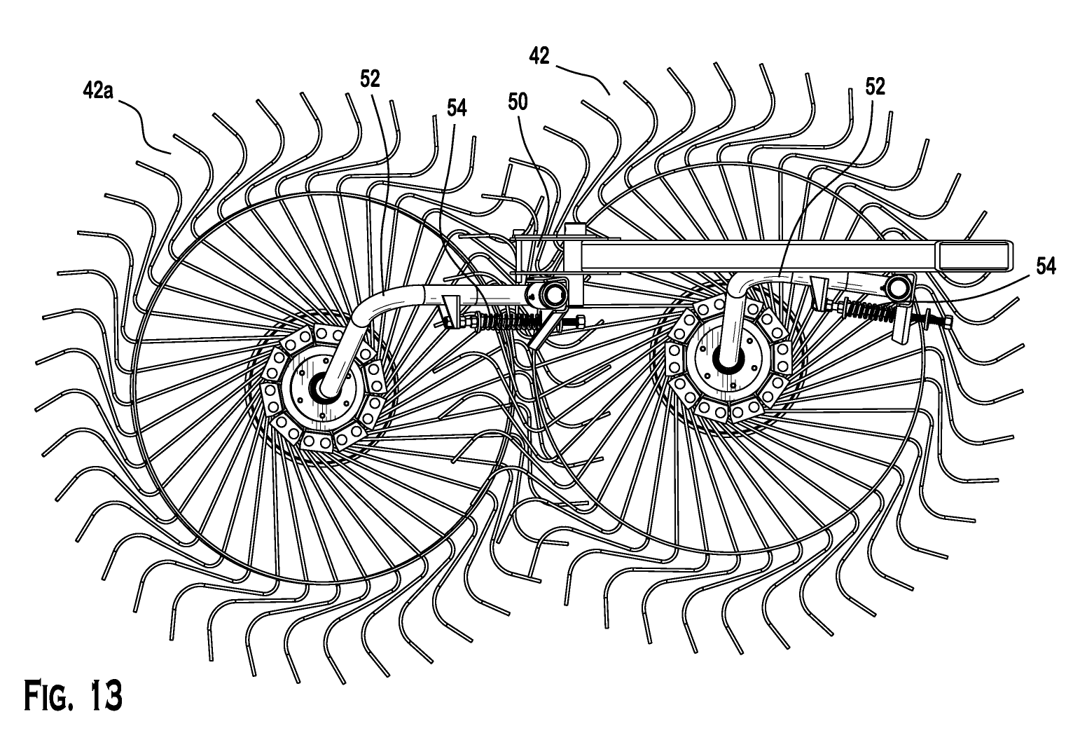

FIG. 13 shows a side view of a trailing end 44 of the rake arm 40, including a pair of rake wheels 42 (including the last rake wheel 42a) and the multi-position support bracket 50. Each rake wheel 42a, 42 is positioned at the end of a support arm 52. As discussed above, the multi-position support bracket 50 attaches to the trailing end 44 of the rake arm 40, which then further connects to a support arm 52 of the last rake wheel 42a. The rake wheels 42, other than the last rake wheels 42a, attach directly to the rake arm 40 without a multi-position support bracket 50.

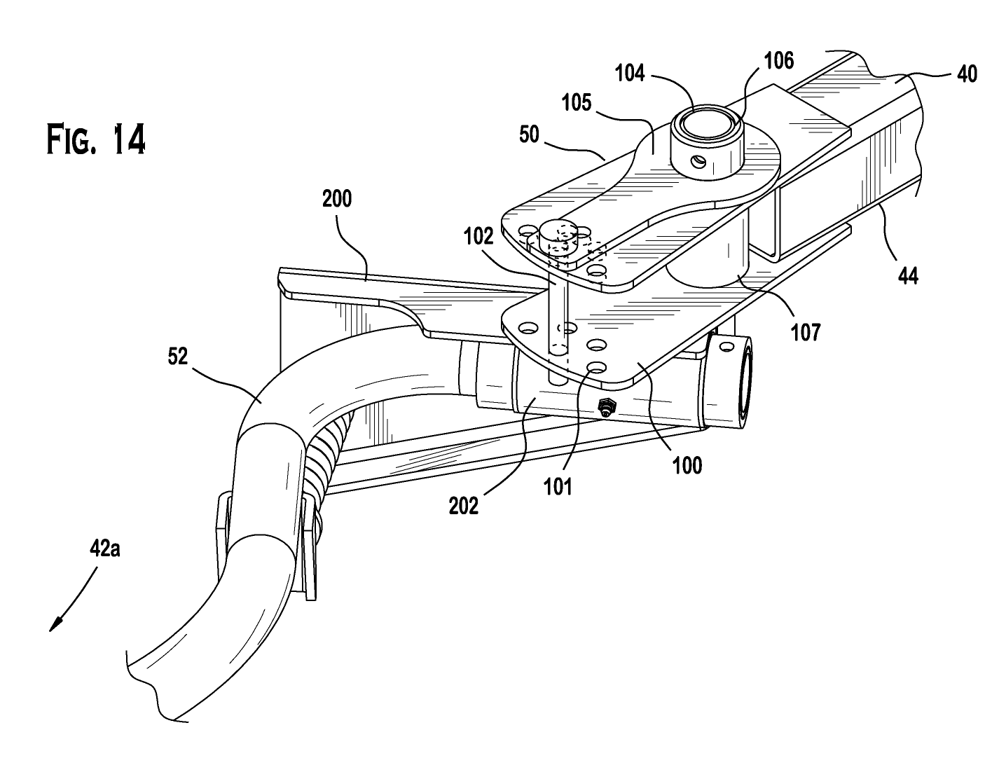

Each rake wheel 42, 42a is positioned at a leading end of the support arm, while an oscillating spring 54 is positioned at the trailing end of the support arm 52. The oscillating spring 54 connects to the support arm 52, as well as a spring bracket 200. In the embodiment shown, the spring bracket 200 is too positioned at a trailing end of the support arm 52 (see FIG. 14). In fact, the spring bracket 200 is welded to a bushing lined receiving column 202. The bushing lined receiving column 202 receives the support arm 52, and allows the support arm 52 to rotate along a vertical axis.

The oscillating spring 54 provides tension on the support arm 52 and attached rake wheel 42a, 42. This tension positions the rake wheel 42, 42a to run along and bias the ground. In fact, the oscillating spring 54 is a compression spring that can be used to adjust the amount of tension on the support arm 52, and therefore on the connected rake wheel 42. In the embodiment shown, adjusting the tension can be performed by screwing or unscrewing the oscillating spring 54. For instance, tightening the oscillating spring 54 would provide more tension on the support arm 52, and cause further bias of the rake wheel 42a, 42 against the ground.

FIG. 14 further illustrates the multi-position support bracket 50, The multi-position support bracket 50 pivotably attached to the trailing end 44 of the rake arm 40, by an angle θ defining the position of the last rake wheel 42a. The multi-position support bracket 50 consists of a support bracket 100 having selected holes 101, a pin 102, and a rotating control arm 104. The support bracket 100 rigidly attaches to the trailing end 44 of the rake arm 40. The rotating control arm 104 comprises a shaft 105 and a lever 106, which rigidly attaches to the shaft 105. The rotating control arm 104 is formed in such a way that the longitudinal axis of the lever 106 is perpendicular to the longitudinal axis of the shaft 105. Accordingly, the shaft 105 and the lever 106 are integral at a right angle.

The shaft 105 of the rotating control arm 52 feeds through a guide tube 107 of the support bracket 100, and then rigidly attaches to the bushing lined receiving column 202, which holds the support arm 52. Since the guide tube 107 is lined with a bushing, the rotating control arm 104 can rotate along the latitudinal axis of the rake arm 40. The lever 106 also includes a hole, which must align with corresponding selected holes 101 of the support bracket 100. The pin 102 feeds through each of the holes of each, and locks the last rake wheel 42 at an optimum operating angle θ.

Hereinafter, descriptions will be given to the function of the embodiment illustrated in the drawings representing the present invention.

FIGS. 1, 2, 5, 6 and 7 show the hay rake 1 in a transport position, which allows the user to transport the hay rake 1 and attached rake arms 40 in an efficient, compact manner. As shown in FIG. 1, both sets of rake arms 40 converge to where each rake arm 40 is almost parallel with the longitudinal axis of the wheeled frame 10 when in the transport position.

According to the invention, and as illustrated in FIG. 2, the user can transition the rake arm 40 from an operable and transport position, and vice versa, using actuators 28. The actuator 28 acts to lower and raise the rake arm 40, by controlling the vertical and horizontal position of the intermediate arm 20. While the intermediate arm 20 acts to support the rake arm 40.

When in the transport position, the actuator 28 is fully contracted and the piston end 81 of the actuator 28 holds the intermediate arm 20 toward the center of the wheeled frame 10 through the second actuator joint 26. Since, the intermediate arm 20 is rigidly attached to the rake arm 40 through a fixed bracket assembly 30, the rake arm 40 and the rake wheels 42 move dependent of the intermediate arm 20.

FIG. 5 clearly illustrates where the actuator 28 connects to the wheeled frame 10, using a first actuator joint 24. The actuator 28 also connects to the intermediate arm 20 using a second actuator joint 26. Both the first and second actuator joint 24, 26 are extremely strong and fully capable of rotating in both a vertical and horizontal axis. As the actuator 28 extends or retracts, a longitudinal and a latitudinal angle between the intermediate arm 20 and the frame changes.

Additionally, the guide rod 74 is capable of full rotation within the bushing lined opening 15. The guide rod 74 rotates along the latitudinal axis of the wheeled frame 10 or the intermediate arm 20. As a result, the first and second actuator joints 24, 26 allow the actuator 28 to rotate in both a vertical and horizontal axis.

Both the first and second actuator joints 24, 26 rotate freely to lower the intermediate arm 20 to an operable position when the actuator 28 is in an extended position, and raise the intermediate arm 20 to a transport position when the actuator 28 is fully contracted.

Although the intermediate arm 20 is rigidly fixed to the rake arm 40 on one end, the intermediate arm 20 may freely move on the other end, by means of a dual axis articulating joint 60. FIG. 5 illustrates the dual axis articulating joint 60, which includes two joints (as discussed above) and connects to the intermediate arm 20 to the wheeled frame 10. The dual axis articulating joint 60 allows the intermediate arm 20 to freely move in both a horizontal and vertical axis. The horizontal axis joint 62 allows the intermediate arm 20, which supports the rake arm 40 and rake wheels 42, to rotate along a horizontal axis, while the vertical axis joint 64 allows the intermediate arm 20 to rotate along a vertical axis.

FIGS. 3 4, 8, and 9 show the hay rake 1 in a transition position, where the intermediate and rakes arms 20, 40 are lowered along a vertical axis and are starting moving along the horizontal axis to an operable position. In transition, the actuator 28 extends outwardly, allowing the intermediate and rakes arms 20, 40 to lower first along a vertical axis. FIG. 3 clearly demonstrates this state of transition.

FIG. 8 shows a perspective view of the actuator 28 in an extending position. The intermediate arm 20 lowers because of the free movement of the dual axis articulating joint 60, specifically the free vertical rotation of the vertical axis joint 64.

As the intermediate arm 20 is lowered, the user may lock the arm into place through a combined use of a rotatable lock 66 and an intermediate arm notch 23. When the rotatable lock 66 is in a locking position, as also illustrated in FIG. 9, the rotatable lock 66 can engage the intermediate arm notch 23 to negate the intermediate arm 20 from vertical movement.

Additionally, FIGS. 8 and 9 further shows a wheeled frame stop 12 and an intermediate arm stop 22. Both stops 12, 22 abut each other at a point when the intermediate arm 20 is brought back along the horizontal axis to a transport position. These stops 12, 22 make sure that contraction of the actuator 28 does not only draw the intermediate arm 20 along the vertical axis, but that the force of the contraction cause the intermediate arm 20 to move vertically once the stops 12, 22 abut each other.

FIGS. 10, 11 and 12 show the hay rake 1 in an operable position, where the intermediate and rakes arms 20, 40 have fully lowered along a vertical axis and extending along the horizontal axis to an operable position.

As the actuator 28 extends to an operable position, the intermediate and rakes arms 20, 40 start to move along the horizontal axis, where the trailing ends 44 of the rake arm 40 converge toward the middle of the longitudinal axis of the wheeled frame 10. The intermediate and rake arms 20, 40 essentially converge to a v-shape.

The fluid movement of the intermediate and rakes arms 20, 40 from an inoperable transport position to an operable position is specifically feasible because of combined flexibility of the first and second actuators joints 24, 26 and the dual axis articulating joint 60. The second actuator joint 26 is positioned high enough on the intermediate arm 20 so that the extending end 81 of the actuator 28 does not contact the dual axis articulating joint 60 when the actuator 28 is fully extended.

The rotatable lock 66 can be position to a locked position in order to engage intermediate arm notch 23. This makes sure that the hay rake 1 stays in the operable position. The intermediate arm stop 22 has now moved away from the wheeled frame stop 12, and will once again abut each other once the hay rake 1 is again transitioned to an inoperable transport position.

FIG. 10 shows a top view of the rake arm 40, including a leading end 46 and a trailing end 44. A multi-position support bracket 50 is positioned on a trailing end 44 of the rake arm 40, which allows a user to adjust the angle θ of a last rake wheel 42a. As the angle θ is brought closer to the longitudinal axis of the rake arm 40, the rake wheel 42 will become more aggressive and gather the hay into tighter windrows. Since the support arm 52 can rotate along the vertical axis of the rake arm 40, an oscillating spring 54 is used to provide tension and bias against the ground, as shown in FIGS. 13 and 14.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A hay rake apparatus comprising:
a wheeled frame;
a rake arm having a trailing end and a leading end;
an intermediate arm having a first end connected to the frame and a second end fixed to the rake arm;
a dual axis articulating joint connecting the frame to the intermediate arm;
a telescoping actuator attached to the wheeled frame by a first actuator joint and to the intermediate arm using a second actuator joint; and
the dual axis articulating joint being pivotable on a horizontal axis and a vertical axis when the telescoping actuator extends or retracts causing a longitudinal and a latitudinal angle between the intermediate arm and the frame to change.

2. The apparatus of claim 1, whereby the rake arm and rake wheels are movable from an inoperable transport position to an operable position.

3. The apparatus of claim 1, wherein the dual axis articulating joint comprises a horizontal axis joint and a vertical axis joint.

4. The apparatus of claim 1, wherein the first actuator joint pivots vertically and horizontally.

5. The apparatus of claim 1, wherein the second actuator joint pivots vertically and horizontally.

6. The apparatus of claim 1, wherein the rake arm further comprises multi-position support bracket attached to the trailing end of the rake arm.

7. The apparatus of claim 1, further comprising a support arm, and an oscillating spring for each rake wheel.

8. The apparatus of claim 6, wherein the multi-position support bracket further comprising a pin that engages selected holes in both a support bracket and rotating control arm.

9. The apparatus of claim 8, wherein a shaft of the control arm rigidly connects to the support arm through a pivot point on the bracket to adjust to a longitudinal angle of the rake wheel.

10. The apparatus of claim 1, wherein the leading end of the first rake arm converges to a point with a second rake arm when the telescoping actuator extends to a final extended position.

11. The apparatus of claim 1, wherein telescoping actuator is configured to position the first rake arm to be substantially parallel to a longitudinal axis of the wheeled frame when in an inoperable transport position for transport, and configured to position the trailing end of the first rake arm to converge to the trailing end of the second rake arm when in an operable position for use.

12. The apparatus of claim 1, whereby the second end of the first intermediate arm rigidly attaches to the first rake arm through a fixed bracket assembly.

13. The apparatus of claim 1, wherein the second actuator joint is elongated through a footing.

14. A rake arm for a hay rake comprising:
at least one rake wheel attached to a leading end of a support arm; and
a spring bracket connected to a bushing lined receiving column, the bushing lined receiving column receiving the support arm and allowing the support arm to rotate along a vertical axis.

15. The rake arm or claim 14, further comprising an oscillating spring attached to the spring bracket and the support arm, the oscillating spring providing tension on the support arm and connecting rake wheel.

16. The rake arm or claim 15, wherein the oscillating spring is a compression spring.

17. The rake arm or claim 16, wherein the oscillating spring is adjustable to an amount of tension on the support arm.

18. The rake arm or claim 17, wherein the oscillating spring adjusts by screwing or unscrewing the oscillating spring.
